(19) United States
(12) Patent Application Publication
(10) Pub. No.: US 2025/0140034 A1
(43) Pub. Date: May 1, 2025

(54) SYSTEMS AND METHODS FOR IMPROVING VEHICLE NAVIGATION AND SAFETY

(71) Applicant: CSAA Insurance Services, Inc., Walnut Creek, CA (US)

(72) Inventor: Anthony Duer, Concord, CA (US)

(21) Appl. No.: 18/890,382

(22) Filed: Sep. 19, 2024

Related U.S. Application Data
(63) Continuation of application No. 63/595,073, filed on Nov. 1, 2023.

(51) Int. Cl. G07C 5/02; B60W 50/00; B60W 50/14; G05B 13/02

(52) U.S. Cl. CPC G07C 5/02; B60W 50/0098; B60W 50/14; G05B 13/0265

(57) ABSTRACT

In one aspect, an example method includes: (a) receiving vehicle sensor data from a vehicle associated with a user profile, wherein the user profile indicates an operator of the vehicle; (b) identifying a plurality of vehicles that share one or more attributes with the vehicle associated with the user profile; (c) collecting operational data associated with the plurality of vehicles; (d) retrieving actuarial data; (e) generating a safe driving model using one or more machine learning models; (f) generating, based on the safe driving model, a safety recommendation, wherein the safety recommendation includes one or more suggestions for actions that improve safety for the operator of the vehicle associated with the user profile; and (g) transmitting, by the modeling computing device, an instruction that causes a mobile computing device to display a graphical indication of the safety recommendation and a confirmation of the displayed graphical indication of the safety recommendation.

### USAGE AND TERMINOLOGY

This application claims priority to U.S. Provisional Application No. 63/595,073, filed on Nov. 1, 2023, which is hereby incorporated by reference in its entirety.

In this disclosure, unless otherwise specified and/or unless the particular context clearly dictates otherwise, the terms “a” or “an” mean at least one, and the term “the” means the at least one.

### SUMMARY

In one aspect, an example computing system for a safe driving system configured for use with an advanced driver assistance systems (“ADAS”) vehicle is disclosed. The example computing system comprises a modeling computing device, wherein the modeling computing device comprises a processor and a non-transitory computer-readable medium, having stored thereon program instructions that, upon execution by the processor, cause the modeling computing device to perform a set of operations comprising: (a) receiving vehicle sensor data from a vehicle associated with a user profile, wherein the user profile indicates an operator of the vehicle; (b) identifying a plurality of vehicles that share one or more attributes with the vehicle associated with the user profile; (c) based on identifying the plurality of vehicles, collecting operational data associated with the plurality of vehicles; (d) retrieving actuarial data, wherein the actuarial data is associated with at least one of: (i) the vehicle; (ii) the user profile; and (iii) the plurality of vehicles; (e) generating a safe driving model using one or more machine learning models, wherein the models are configured to generate recommendations that increase driver safety using at least one of the following: (i) the received vehicle sensor data, (ii) the collected operational data, and (iii) the retrieved actuarial data; and (f) generating, based on the safe driving model, a safety recommendation, wherein the safety recommendation comprises one or more suggestions for actions that improve safety for the operator of the vehicle associated with the user profile. The example computing system further comprises a mobile computing device associated with the user profile, wherein the mobile computing device comprises a processor and a non-transitory computer-readable medium, having stored thereon program instructions that, upon execution by the processor, cause the mobile computing device to perform a set of operations comprising: (a) receiving, from the modeling computing device, the safety recommendation; (b) displaying, via a user interface of the mobile computing device, a graphical indication of the safety recommendation; and (c) receiving, via the user interface of the mobile computing device, a confirmation of the displayed graphical indication of the safety recommendation.

In another aspect, an example method is disclosed. The method includes (a) receiving, by a modeling computing device, vehicle sensor data from a vehicle associated with a user profile, wherein the user profile indicates an operator of the vehicle; (b) identifying, by the modeling computing device, a plurality of vehicles that share one or more attributes with the vehicle associated with the user profile; (c) based on identifying the plurality of vehicles, collecting, by the modeling computing device, operational data associated with the plurality of vehicles; (d) retrieving, by the modeling computing device, actuarial data, wherein the actuarial data is associated with at least one of: (i) the vehicle; (ii) the user profile; and (iii) the plurality of vehicles; (e) generating, by the modeling computing device, a safe driving model using one or more machine learning models, wherein the models are configured to generate recommendations that increase driver safety using at least one of the following: (i) the received vehicle sensor data, (ii) the collected operational data, and (iii) the retrieved actuarial data; (f) generating, by the modeling computing device, based on the safe driving model, a safety recommendation, wherein the safety recommendation comprises one or more suggestions for actions that improve safety for the operator of the vehicle associated with the user profile; and (g) transmitting, by the modeling computing device, an instruction that causes a mobile computing device to display a graphical indication of the safety recommendation and a confirmation of the displayed graphical indication of the safety recommendation.

### BRIEF DESCRIPTION OF THE DRAWINGS

FIG. 1 is a simplified block diagram of an example computing device.

FIG. 2A is a safe driving system configured for use with a vehicle in a first state.

FIG. 2B is a safe driving system configured for use with a vehicle in a second state.

FIG. 3A is an example mobile device of a safe driving system and graphical user interface in a first state.

FIG. 3B is the example mobile device of the safe driving system and graphical user interface of FIG. 3A, but in a second state.

FIG. 3C is the example mobile device of the safe driving system and graphical user interface of FIGS. 3A-3B, but in a third state.

FIG. 3D is the example mobile device of the safe driving system and graphical user interface of FIGS. 3A-3C, but in a fourth state.

FIG. 3E is the example mobile device of the safe driving system and graphical user interface of FIGS. 3A-3D, but in a fifth state.

FIG. 3F is the example mobile device of the safe driving system and graphical user interface of FIGS. 3A-3E, but in a sixth state.

FIG. 3G is the example mobile device of the safe driving system and graphical user interface of FIGS. 3A-3F, but in a seventh state.

FIG. 4 is a flow chart of an example method.

### DETAILED DESCRIPTION

### I. Overview

Transportation technologies have evolved at a rapid pace over the past decade, particularly in the field of autonomous and semi-autonomous vehicles. Nevertheless, insurance companies are regularly required to evaluate driver safety and potential factors underlying insurance policies associated with these transportation technologies.

Conventionally, insurance companies considered numerous factors in connection with insurance premiums for transportation technologies, including, for example, an operator's accident history, the make, model, and type of a motor vehicle to be insured, and other such factors. For over a century, a vehicle purchased by the consuming public would typically be the same vehicle from the time it was manufactured until its use was discontinued. Although some minor changes would be made throughout the life and operation of the vehicle (e.g., tire changes, oil changes, maintenance, etc.), it would be, substantially, the same vehicle that was purchased until it was no longer fit to operate. And, vehicles of a given make and model would typically carry the same mechanical and operational issues as other vehicles with the same make and model. This consistency of manufacturing and operation led to assessing safety and operation of specific vehicles under a fairly direct and reliable process, which resulted in more than a hundred years' worth of data and experience of operating these vehicles.

However, the advent of autonomous and semi-autonomous vehicles has drastically affected this process and caused many companies (including insurance companies) to reconsider how safety, operation, and consistency of vehicles (even those of the same make and model) are to be evaluated and how the process and evaluation will evolve over time. For example, vehicles of the same make and model using ADAS cannot be assumed to share the same issues and features as one another. In a further aspect, an operator who chooses not to download software updates for the vehicle's built in pedestrian detection system has a vehicle that poses a risk, distinct from its peers, in areas with high volumes of foot traffic. For example, two vehicles made on the same day, in the same factory, from the same parts can no longer be said to “handle” or “behave” the same way now that software can dictate how a given vehicle reacts to certain situations instead of it just being in the hands of the operator. Thus, relying on conventional methods no longer allows insurance companies to give reliable safety, operational, and insurance assessments, much less update assessments or policies in response to improvements in a given vehicle.

If, however, the insurance company could provide an efficient, effective, and novel solution for modeling safe driving behavior based on leveraging their actuarial data and existing and evolving transportation technologies, then the overall driver safety associated with operating a vehicle by a specific user would determinable, and insurance premiums could be more accurately forecasted. These forecasts would, in turn, allow for the insurance companies to make recommendations the operator of a vehicle, thereby improving overall driver safety. Further, this improvement would benefit operators and passengers of autonomous and semi-autonomous vehicles, and ride-sharing platforms, alike. Put another way, if the driver safety associated with evolving transportation technologies could be determined more comprehensively, intelligently, and accurately, then the safety and well-being of all parties involved would be improved.

Accordingly, features of the present disclosure can help to address these and other issues to provide an improvement to select technical fields. More specifically, features of the present disclosure help address issues within and provide improvements for select technical fields, which include, for example, computer-based systems for collecting and analyzing data from vehicle sensors, mobile computing devices, and/or other sources, modeling safe driving behavior for the vehicle associated with a user profile based on this data, providing safe driving recommendations in connection with the vehicles based on one or more attributes of the vehicle that reduce the accident rate, providing analysis and incentives for improving operator behavior, and computing devices, applications, and graphical user interfaces (GUIs) used by insurance customers and policyholders, as well as other entities.

Embodiments of the present invention provide methods, systems, and devices that allow insurance policy holders and insurance companies to effectively analyze, determine, and display attributes (e.g., accident rate) associated with operating a vehicle and/or being a passenger in a vehicle that is missing certain software updates or safety features, or is being operated by a user with certain behavioral patterns.

More specifically, example embodiments relate to methods, systems, and devices that allow a safe driving system configured for use with a vehicle to assess various attributes associated with the vehicle and increase driver safety by leveraging one or more transportation technologies (e.g., vehicle sensor data associated with a user profile, vehicles that share one or more attributes with the vehicle associated with the user profile, etc.). In a further aspect, these example embodiments also implement different means of analyzing and conveying the results of this analysis (e.g., displaying graphical indicating the accident rate associated with declining to update to the most recent software).

To facilitate this determination and the potential responsive actions taken by the safe driving system, the safe driving system may use one or more components to carry out various steps of this process. For example, the safe driving system may include a modeling computing device (e.g., a cloud based computing device that receives data from a number of sources and uses a machine learning model to create one or more models based on the received data) and a mobile computing device (e.g., a smartphone associated with the user profile). These computing devices can be used to perform various operational functions within the safe driving system to determine and display various driver safety recommendations associated with operating the vehicle.

In some examples, the modeling computing device may collect data and may do so from a number of sources. For example, the modeling computing device may collect vehicle sensor data from the vehicle associated with the user profile. This sensor data may include data from autonomous and semi-autonomous vehicles, as well as one or more sensors equipped on other types of vehicles, all sharing one or more attributes with the vehicle associated with the user profile.

In example embodiments these vehicle sensors may include: (i) GPS sensors (e.g., to determine routes taken by the operator of the vehicle), (ii) accelerometer sensors (e.g., to determine speed and/or how the operator decelerates the vehicle), (iii) weather sensors (e.g., to determine the weather in which the operator tends to operate the vehicle), (iv) collision sensors (e.g., to determine if the vehicle has been involved in a collision), (v) pedestrian detection sensors (e.g., to determine how the vehicle reacts to the presence of pedestrians), and (vi) camera sensors (e.g., to determine how the operator behaves inside the vehicle), among other possibilities.

In other examples, the vehicle sensor data may also incorporate behavior data of the operator of the vehicle collected by the mobile computing device associated with the user profile such as: (i) operator interaction history (e.g., how often the operator interacts with the mobile computing device while operating the vehicle) and (ii) gazing direction (e.g., where the operator's eyes are pointed towards while operating the vehicle), among other things.

In example embodiments, the modeling computing device may also identify a plurality of vehicles that share one or more attributes with the vehicle associated with the user profile in order to collect operational data. These attributes may include: (i) the make and model of the vehicle, (ii) one or more purchased options of the vehicle (e.g., heated seats), (iii) one or more potential vehicle options, (iv) an operating system of the vehicle (e.g., Linux), (v) an ADAS software developer of the vehicle (e.g., FORD®, GMC®, TESLA®), and (vi) one or more available vehicle subscription services of the vehicle (e.g., subscriptions for remote-start key fobs), among other possibilities.

In example embodiments, operational data collected from the plurality of vehicles may include: (i) use of ADAS, (ii) success rate of ADAS detection of pedestrians, (iii) success rate of ADAS response to detected pedestrians, (iv) success rate of ADAS detection of other vehicles, (v) success rate of ADAS response to detected other vehicles, (vi) success rate of ADAS detection of road conditions, (vii) success rate of ADAS response to detected road conditions, (viii) success rate of ADAS detection of traffic conditions, (ix) success rate of ADAS response to detected traffic conditions, (x) success rate of ADAS path suggestion through environment, and (xi) details of a respective software of one or more vehicles, among other possibilities.

In example embodiments, the modeling computing device may collect actuarial data which may be associated with at least one of: (i) the vehicle, (ii) the user profile, and (iii) the plurality of vehicles, among other possibilities. In other examples, the actuarial data may include historical actuarial data compiled by an insurance company.

In example embodiments, this actuarial data may include: (i) the age of the operator of the vehicle, (ii) age of one or more operators of one or more of the plurality of vehicles, (iii) an accident record of the operator of the vehicle, (iv) an accident record of one or more operators of one or more of the plurality of vehicles, (v) accident rate of a make and model of the vehicle, (vi) costs associated with repairing damage from accidents of a make and model of the vehicle, (vii) features of the vehicle, and (viii) safety ratings of the vehicle, among other things.

In example embodiments, once the modeling computing device collects the vehicle sensor data from the vehicle associated with the user profile, operational data associated with the plurality of vehicles, and the actuarial data, the modeling computing device may also generate and maintain one or more resources to interpret this data (e.g. one or more resources securely stored on a server and/or database associated with the modeling computing device and/or insurance company). For example, the modeling computing device may use one or more machine learning models to interpret this data and generate one or more models based on this collected data.

In an example embodiment, the modeling computing device may generate a model that approximates the accident rate of operating a vehicle without certain features or using outdated software (e.g., the software used for the ADAS pedestrian detection system is one or more versions behind). To generate this safe driving model, the modeling computing device may use one or more machine learning models and/or sources of information for the one or more machine learning models.

For example, the modeling computing device may use vehicle sensor data from the vehicles associated with the user profile, operational data from a plurality vehicles sharing one or more attributes with the vehicle associated with the user profile, and actuarial data to utilize and/or train a machine learning model to generate a safe driving model that indicates the risk associated with certain behavior or outdated vehicle features. To facilitate this process, the modeling computing device could use the following example models, including a logistic regression model (e.g., to predict the probability that a vehicle operator will have an accident) and/or a linear model (e.g., to predict how much the accident will cost, including a predictive analysis on the frequency and severity). In example embodiments, to further refine and train these models, data from the autonomous or semiautonomous vehicle may be incorporated into the model and/or the training set for the model (e.g., a combined data set of ADAS data, vehicle sensor data, vehicle data, operator/driver data, and location data may all be incorporated). Other examples are possible.

For example, other models may improve the performance of the modeling computer device to more accurately leverage vehicle sensor data from the vehicle associated with the user profile, operational data from a plurality vehicles sharing one or more attributes with the vehicle associated with the user profile, and actuarial data to more accurately generate a safe driving model that indicates the risk associated with certain behavior or outdated vehicle features. These models may include one or more naïve Bayes machine learning models, K-nearest neighbor models, deep learning models, gradient boosting regression models, logistic regression models, and many others. In a further aspect, a number of factors may influence which models (or combination of models) are appropriate at any given time. For example, different software, different vehicle attributes, or locations with a large number of accidents (with large amounts of corresponding sensor and/or environmental data), may provide circumstances where other models are more appropriate (e.g., where there may be enough accident data that a Bayesian independence assumption is not required).

In other example embodiments, the data being fed into the machine learning algorithms may be processed using a plurality of data compression techniques. The data may be compressed by combining variables with a high correlation in order to reduce overfitting by the modeling device (e.g., correlations between operator height and age or profession and frequency of trips). This compressed data may be used to improve pre-ingestion of the machine learning model or used to improve real time analysis done by the safe driving model. To process this data, the modeling computing device may use one or more data compression techniques.

For example, the modeling computing device may use principle component analysis to compress the data collected from the vehicle sensors from the vehicle associated with the user profile, operational data from a plurality vehicles sharing one or more attributes with the vehicle associated with the user profile, and actuarial data.

For example, other data compression techniques may improve the performance of the modeling computing device to more accurately leverage the vehicle sensor data from the vehicle associated with the user profile, operational data from a plurality vehicles sharing one or more attributes with the vehicle associated with the user profile, and actuarial data that will be fed into the machine learning algorithms. These models may include a factor analysis method and many others. In further aspects, a number of factors may influence which models (or combination of models) are most appropriate at any given time. For example, the size of the data set or the number of variables being considered, may provide circumstances where other models are more appropriate (e.g., there may be indicators of a latent factor that favors factor analysis).

Once the modeling computing device generates the safe driving model, the modeling computing device may use the safe driving model in various ways. For example, the safe driving model may be used to determine safe driving recommendations associated with the operation of the vehicle by the user profile, with the current software, or with the currently available features. In a further aspect, the modeling computing device may receive a request for safe driving recommendations from the user profile corresponding to the safe driving model. The request may come from a computing device within the vehicle (e.g., from a mobile computing carried by the operator), among other possibilities (e.g., from a mobile computing device carried by a passenger in the vehicle).

In an example embodiment, based on the received request, the modeling computing device may also identify various attributes associated with making one or more safe driving recommendations for the operation of the vehicle associated with the user profile, among other possibilities. The identified attributes of the one or more safe driving recommendations may also be based on the safe driving model generated by the modeling computing device. These attributes may include, for example, the risk associated with disabling certain ADAS features (e.g., disabling assisted driving in favor of full self-driving). These attributes may include, for examples, the insurance costs associated with the safety recommendations (e.g., increased or decreased premiums associated with disabling and enabling, respectively, certain features). Other examples are possible.

In a further aspect, the modeling computing device may continuously or periodically monitor further received requests and/or other information (e.g., newly released software updates for the vehicles sensors) in order to update the attributes, safe driving model, or both. The modeling computing device may also provide real-time and/and or periodic analysis of the updated attributes (e.g., the updated risk associated with further delays in updating the software). In this regard, the safe driving model may enable the insurance company to provide a number of different pricing and/or insurance models for the operator of the vehicle. For example, the safe driving model may enable the insurance company to provide a reduction in monthly insurance premiums in exchange for updating the ADAS or other software. Such insurance reductions could be beneficial for ride-share platform drivers who typically have higher insurance premiums. Other examples are possible.

In a further aspect, the insurance premiums calculated prior to the operator accepting any safety recommendations could be adjusted for any changes made by the operator. For example, because the modeling computing device may continuously or periodically monitor further received requests and/or other information in order to provide real-time and/or periodic analysis of the updated attributes, safe driving model, or both, the modeling computing device may adjust the insurance premium based on events that occur after the initial sign in by the operator. For example, if the operator later decides to enable full self-driving after agreeing to use the vehicle ADAS, the refund could be cancelled or the premiums could be increased for that month as a result of the increased risk. In this regard, the real time and/or periodic analysis provided by the modeling computing device allows for several insurance premium models.

In another example, the safe driving model may be used to collect accident and loss data for vehicles that are not moving (e.g., parked vehicles) and use collected data to construct a safe driving model for stationary vehicles. In this regard, risks and/or insurance premiums may be generated for a given interval of time that a vehicle is parked at a given location and the operator could be encouraged to park in safer locations by offering certain insurance benefits (e.g., encouraging finding a parking garage over street parking).

In a further aspect, although the safe driving model may also include generating recommendations based on predicted future improvements in ADAS related software based on improvements over previous iterations of software, and generating recommendations based on actual improvements in ADAS related software exceeding predictions. For example, if the safe driving model estimates that the use of certain ADAS software will lead to a ˜5% reduction in the accident rate, it may assess a specific insurance reduction associated with enabling automatic updates to that software. Further, if the actual reduction in the accident rate exceeds the predicted value further savings may be assessed for the operator of the vehicle.

Turning back to the safe driving system, the safe driving system may also include a mobile computing device that interacts with the modeling computing device. The mobile computing device may also collect data and may do so from a number of sources. For example, the mobile computing device may collect data inside of the vehicle associated with the user profile. This data may include data from one or more components of the mobile computing device including the microphone, camera, time sensors, accelerometer sensors, GPS sensors, and/or device interaction sensor (e.g., a touchscreen of the mobile computing device that determines when a user engages with the mobile computing device), among other possibilities.

In a further aspect, the data collected by the mobile computing device may come from components of the mobile computing device (e.g., a device interaction sensor on the mobile computing device) and/or from other devices with which the mobile computing device may interact. For example, the mobile computing device may be powered by and/or integrated with a vehicle (e.g., as a head unit display inside the vehicle) and/or connected to the vehicle via one or more communication ports (e.g., a smartphone connected to the vehicle via a USB port on the vehicle and/or via a BLUETOOTH® communication protocol), among other possibilities. Additionally, by integrating with the vehicle, the mobile computing device may leverage and/or invoke action from one or more vehicle components (e.g., the mobile computing device may receive data from one or more components of the vehicle via its connection with the vehicle). In an example embodiment, the data collected by the mobile computing device may be used in various ways, including to determine driver behavior while the driver is operating the vehicle (e.g., whether the driver is interacting with the mobile computing device while driving), among other possibilities.

For example, the mobile computing device and/or other components of the driver safety system and/or vehicle may detect driver inattention and/or impairment. For example, the mobile computing device and/or other components of the safe driving system and/or vehicle may use one or more sensors to detect a driver attribute (e.g., to detect the driver touching the screen while driving). In another example, the mobile computing device and/or other components of the driver safety system and/or vehicle may use one or more sensors to detect an operational attribute of the vehicle, which may also indicate an attribute of the driver (e.g., one or more sensors monitoring lane crossing or variance during driving which may indicate driver distraction, sleepiness, etc.). Other examples are possible.

In a further aspect, the mobile computing device may also send any or all of this data to the modeling computing device to further inform and/or update the safe driving model. For example, the mobile computing device may send the frequency with which the operator interacts with the phone while driving (e.g., switching applications) to the modeling computing device. In response, the modeling computing device may use this updated driver attentiveness data to update one or more safe driving recommendations or make new recommendations (e.g., recommending locking the device while the vehicle is in motion). Other examples are possible.

In a further aspect, in an example embodiment, once the modeling computing device identifies new recommendations or updates previous recommendations concerning operator behavior, the modeling computing device may send those recommendations or updates to the mobile computing device. Once the mobile computing device receives the recommendations or updates from the modeling computing device, the mobile computing device may take one or more responsive actions.

In an example embodiment, the mobile computing device may display, via a user interface of the mobile computing device, a graphical indication of the safety recommendations. In one example, the mobile computing display may display a graphical indication of: (i) reductions in monthly premiums, (ii) partial rebates, and (iii) reductions in deductibles. In a further aspect, the mobile computing device may also update this display at various times when the operator first logs into the user profile, or when the vehicle is no longer in motion. Other examples are possible.

For example, in another example embodiment, the mobile computing device may display, via a user interface of the mobile computing device, a graphical indication of the safe driving recommendation for the operator of the vehicle to alter his/her/its behavior. (e.g., “Disable cell phone interaction while the car is driving to save money on your insurance premiums.”). In a further aspect, the mobile computing device may also emit, via one or more speakers of the mobile computing device, an audible indication that the operator may be in violation of a previously accepted safe driving recommendation (e.g., an audible emission for the operator to “cease interacting with the mobile device” and/or “your premiums will increase if behavior continues”), among other possibilities.

In a further aspect, although the safe driving model has been described in connection with one or more example display configurations, it should be well understood to one of the art that these are merely examples. Indeed, the information displayed by the safe driving system via the mobile computing device may be displayed via one or more software applications and/or websites owned or developed by the insurance company, as well as one or more software applications and/or websites owned or developed by other entities, database, or website (FORD®, TELSA®, etc.).

These systems, methods, and devices may provide technical advantages of vehicle operation by modeling the driver safety risk of operating the vehicle with or without certain features, subscriptions, or settings. Other features of the systems, methods, and devise are described in further detail in the example embodiments provided below.

### II. Example Architecture and Operations

### A. Computing Device

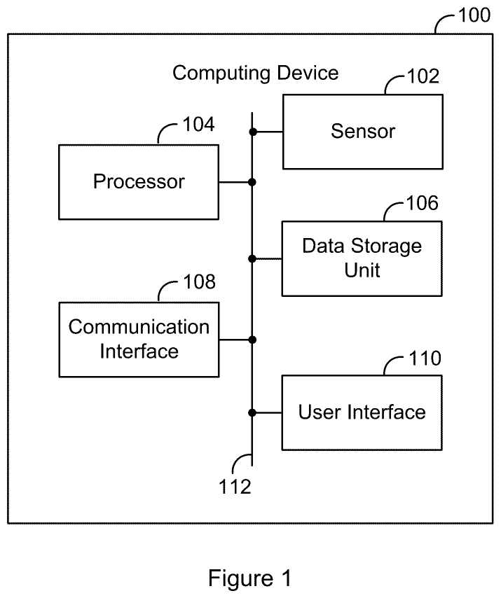

FIG. 1 is a simplified block diagram of an example computing device 100. The computing device 100 can be configured to perform and/or can perform one or more acts and/or functions, such as those described in this disclosure. The computing device 100 can include various components, such as a sensor 102, a processor 104, a data storage unit 106, a communication interface 108, and/or a user interface 110. Each of these components can be connected to each other via a connection mechanism 112.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The sensor 102 can include sensors now known or later developed, including but not limited to accelerometer sensors, a sound detection sensor, a motion sensor, a humidity sensor, a temperature sensor, a proximity sensor, a location sensor (e.g., a GPS sensor), time sensors (e.g., a digital clock), camera sensors (e.g., cameras on a mobile computing device), biometric sensors (e.g., heartrate sensor, oxygen sensor, fingerprint sensor), device interaction sensors (e.g., a touch screen and/or retinal scanner on a wearable computing device and/or a mobile computing device, such as a smartphone), and/or a combination of these sensors, among other possibilities.

The processor 104 can include a general-purpose processor (e.g., a microprocessor) and/or a special-purpose processor (e.g., a digital signal processor (DSP)). The processor 104 can execute program instructions included in the data storage unit 106 as discussed below.

The data storage unit 106 can include one or more volatile, non-volatile, removable, and/or non-removable storage components, such as magnetic, optical, and/or flash storage, and/or can be integrated in whole or in part with the processor 104. Further, the data storage unit 106 can take the form of a non-transitory computer-readable storage medium, having stored thereon program instructions (e.g., compiled or non-compiled program logic and/or machine code) that, upon execution by the processor 104, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 108 and/or the user interface 110. The data storage unit 106 can also store other types of data, such as those types described in this disclosure.

The communication interface 108 can allow the computing device 100 to connect with and/or communicate with another entity, such as another computing device, according to one or more protocols. In one example, the communication interface 108 can be a wired interface, such as an Ethernet interface. In another example, the communication interface 108 can be a wireless interface, such as a cellular or WI-FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

The user interface 110 can include hardware and/or software components that facilitate interaction between the computing device 100 and a user of the computing device 100, if applicable. As such, the user interface 110 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, and/or a mobile smartphone. Additionally, as used herein, “mobile computing device” describes computing devices that are highly mobile (including a laptop, a tablet, and/or a mobile phone), as well as computing devices that are not as mobile (including a desktop computer, etc.). In a further aspect, the features described herein may involve some or all of these components arranged in different ways, including additional or fewer components and/or different types of components, among other possibilities.

### B. Example Navigation and Safety Computing System

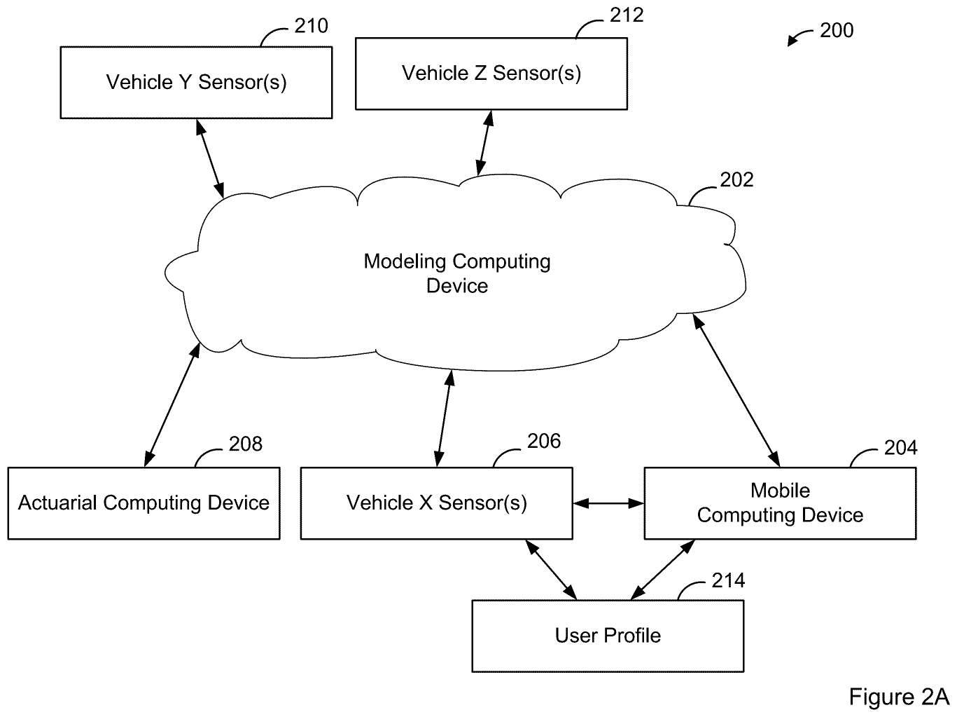

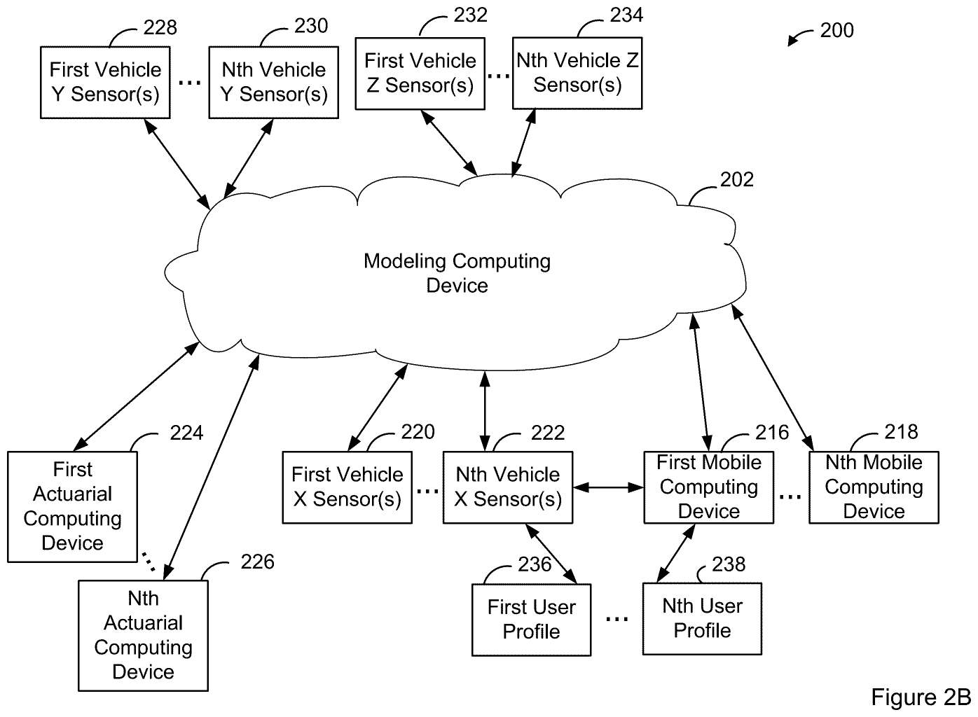

FIG. 2A is a safe driving system 200 configured for use with a vehicle in a first state. The safe driving system 200 can perform various acts and/or functions related to collecting vehicle sensor data, actuarial computing data, and/or data from a mobile computing device, all of which may be connected to one or more user profiles. The data collected may then be used to generate a model for safe driving behavior and recommend one or more responsive actions to increase driver safety. In this disclosure the term “computing system” means a system that includes at least one computing device, such as computing device 100. In some instances, a computing system can include one or more other computing systems.

It should be readily understood that computing device 100, safe driving system 200, and any of the components thereof, can be physical systems made up of physical devices, cloud-based systems made up of cloud-based devices that store program logic and/or data of cloud based applications and/or services (e.g., for performing at least one function of a software application or an application platform for computing systems and devices detailed herein), or some combination of the two.

In any event, the safe driving system 200 can include various components, such as a modeling computing device 202 (shown here as a cloud based computing device), a mobile computing device (204), a vehicle sensor 206 for some vehicle “X,” an actuarial computing device 208, a vehicle “Y” sensor 210, a vehicle “Z” 212, and a user profile 214, each of which can be implemented as a computing system or part of a computing system.

The safe driving system 200 can also include connection mechanisms (shown here as lines with arrows at each end (i.e., “double arrows”)), which connect modeling computing device 202, a mobile computing device 204, a vehicle “X” sensor 206, an actuarial computing device 208, a vehicle “Y” sensor 210, a vehicle “Z” sensor 212, and a user profile 214, and may do so in a number of ways (e.g., a wired mechanism, wireless mechanisms and communications protocols, etc.).

In practice the safe driving system 200 is likely to include many of some or all of the example components described above, such as the modeling computing device 202, a mobile computing device 204, a vehicle “X” sensor 206, and an actuarial computing device 208, which can allow many policy holders and/or potential customers to communicate and interact with the insurance company, insurance company to communicate and interact with the policy holder and/or potential customer, and so on.

Other computational actions, displayed messages, audible alerts, visual alerts, and configurations are possible.

The safe driving system 200 and/or components thereof can perform various acts and/or functions (many of which are described above). Examples of these related features will now be described in further detail.

Within safe driving system 200, modeling computing device 202 may collect data from a number of sources connected and/or related to the user profile 214. The user profile 214 is used to identify the operator of the vehicle and may include: (i) the insurance policy held by the operator, (ii) the operator's name, (iii) the operator's age, (iv) the operator's vehicle, (v) the operator's marital status, and (vi) the number of children the operator has, among other possibilities.

In one example the modeling computing device 202 may collect data from one or more mobile computing devices 204 (e.g., used in connection with one or more vehicles) connected to the user profile 214. In a further aspect, these one or more may include a mobile computing device associated with the driver (e.g., the driver's cellular device/smartphone), a mobile computing device associated with the vehicle (e.g., a computing system, and/or head unit installed in the vehicle), or both, among other possibilities. The data collected from these mobile computing devices may include operational data of a vehicle (e.g., speed and direction of travel for the vehicle), as well as data indicating driver behavior inside the vehicle, including: (i) how often the operator interacts with the mobile computing device while operating the vehicle, (ii) a gazing direction of the operator of the mobile computing device while operating the vehicle, and (iii) how often the operator interacts with one or more particular applications on the mobile computing device while operating the vehicle, among other possibilities. This data may come from one or more of the following sensors of the mobile computing device, and/or vehicle, associated with the user profile 214: (i) GPS sensors, (ii) accelerometer sensors, (iii) device interaction sensor, (iv) time sensor, (v) weather sensors, (vi) collision sensors, and (vii) camera sensors, among other possibilities.

In another example, modeling computing device 202 may collect data from one or more vehicle “X” sensors 206 associated with a user profile 214. This vehicle sensor data may include one or more of the following for one or more vehicles associated with a user profile 214: (i) frequency of which operator drives the vehicle, (ii) accelerometer data, (iii) routes taken by the operator of the vehicle, (iv) average distance per day driven by the operator of the vehicle, (v) environmental condition in which the operator of vehicle operates the vehicle, (vi) behavior data of the operator of the vehicle collected by the mobile computing device associated with the user profile, and (vii) behavior data of the operator of the vehicle based on the received vehicle sensor data, among other possibilities.

In yet another example, modeling computing device 202 may collect data from one or more actuarial computing devices 208 collecting data regarding, and/or otherwise indicating information about, operators and vehicles similar to the operator and vehicle associated with the user profile 214. The actuarial data may include historical actuarial data compiled by an insurance company, among other things.

In further examples, modeling computing device 202 may collect data from one or more vehicle sensors “Y” 210 and “Z” 212 which share one or more attributes of a vehicle associated with a user profile 214. These vehicle attributes may include one or more of the following: (i) the make and model of the vehicle, (ii) one or more purchased options of the vehicle, (iii) one or more potential vehicle options of the vehicle, (iv) an operating system of the vehicle, (v) an ADAS software developer of the vehicle, and (vi) one or more available vehicle subscription services of the vehicle, among other things.

Once the modeling computing device 202 collects data from the mobile computing device 204, vehicle “X” sensor 206, actuarial computing device 208, vehicle “Y” and “Z” sensors 210 and 212, and user profile 214, and/or other sources, the modeling computing device 202 may generate a safe driving model using one or more machine learning models (e.g., a naïve Bayes classifier machine learning model). In example embodiments, this safe driving model may be constructed using any or all of the data collected from the mobile computing device 204, vehicle “X” sensor 206, actuarial computing device 208, vehicle “Y” and “Z” sensors 210 and 212, and user profile 214, and/or other sources. In a further aspect, the safe driving model may indicate, for the operator of the vehicle, the risk of operating the vehicle without taking certain actions. The actions may include one or more of the following: (i) recommendations to update a software associated with the vehicle, (ii) a recommendation to delegate more control to the ADAS, and (iii) a recommendation to activate additional safety features of the vehicle. Furthermore, the safe driving model may be updated over time based on further data collected from the mobile computing device 204, vehicle “X” sensor 206, actuarial computing device 208, vehicle “Y” and “Z” sensors 210 and 212, and user profile 214, and/or other sources

After the safe driving model is generated and/or regenerated by the modeling computing device 202, the modeling computing device may receive a request for safe driving recommendations. In a further aspect, this request may come from the mobile computing device 204, and/or other sources.

In one example, once the request is received by the modeling computing device 202, the modeling computing device may identify attributes associated with increased driver safety. These attributes associated with increased driver safety may be based on attributes shared between one or more vehicles or operators with the vehicle and or operator associated with the user profile 214, among other possibilities. Further, because the safe driving model may be updated over time based on further data collected from the mobile computing device 204, vehicle “X” sensor 206, actuarial computing device 208, vehicle “Y” and “Z” sensors 210 and 212, and user profile 214, and/or other sources, the attributes identified by the modeling computing device 202 may be updated as well. These attributes include, for example, the risk and/or insurance premiums associated with using outdated versions of the ADAS software, enabling or disabling certain features, and purchasing/not purchasing certain vehicle additions, among other possibilities. Modeling computing device 202 can also send these attributes and updated attributes to the mobile computing device 204.

In another example, the mobile computing device 204 may send data to the modeling computing device 202 and, in response, the modeling computing device may identify suggestion prompts for the mobile computing device, including suggestions prompts relating to improving driver behavior and/or driver decisions (e.g., choosing to update the ADAS software), among other possibilities. Further, because the safe driving model may be updated over time based on further data collected from the mobile computing device 204, vehicle “X” sensor 206, actuarial computing device 208, vehicle “Y” and “Z” sensors 210 and 212, and user profile 214, and/or other sources, the suggestion prompts identified by the modeling computing device 202 may be updated as well. Modeling computing device 202 can also send these suggestion prompts and updated suggestion prompts to the mobile computing device 204.

Once the mobile computing device 204 receives the attributes and/or suggestion prompts identified by the modeling computing device 202, the mobile computing device may display (e.g., via a user interface of the mobile computing device), one or more graphical indications of the following: (i) a prompt to sign in to the user profile, (ii) a recommendation to update a software associated with the vehicle, (iii) a recommendation to delegate more control to the ADAS, (iv) a recommendation to activate additional safety features of the vehicle, and (v) a graphical display of the relative increase in driver safety from accepting the respective safe driving recommendations, among other possibilities. In a further aspect, the mobile computing device may also update this display at various times when the vehicle is turned on or in park (or other times) for a variety of reasons (e.g., in response to the modeling computing device 202 updating the safe driving model over time based on further data collected from the mobile computing device 204, vehicle “X” sensor 206, actuarial computing device 208, vehicle “Y” and “Z” sensors 210 and 212, and user profile 214, and/or other sources). Other examples are possible.

In some examples, some or all of the data collected in connection the user profile may be used to generate a digital record and/or representation of the user profile and/or one or more users associated with the user profile. For example, if a user associated with a particular user profile elects to change insurers, then some or all of the data collected in connection with the particular user profile may be transferred to the new insurer. In another example, if a user associated with a particular user profile would like to use the data collected in connection with the particular user profile to validate one or more requests, such requests may be validated by the generated digital record and/or representation of the user profile. For example, if a transportation agency requests that a driver illustrate that his/her driving has improved since a particular event (e.g., a traffic violation), the user profile data may be transferred to the agency, potentially in a digital record/representation that has had all personally identifiable information (PII) removed. In another example, some or all of the data collected in connection with the particular user profile may be used to validate that the user of the vehicle that is currently signed into a particular user profile is actually the user that is associated with the user profile (e.g., by detecting driving anomalies compared to how the user has operated a vehicle in connection with the vehicle in the past). Other examples are possible.

Other computations actions, displayed graphical indications, alerts, and configurations are possible.

For example, FIG. 2B is the example safe driving system 200 in FIG. 2A configured for use with a vehicle in a second state.

Similar to FIG. 2A, the safe driving system illustrated in FIG. 2B can include various components such as a modeling computing device 202 (shown here as a cloud-based computing device), one or more mobile computing devices (shown here as a first mobile computing device 216 up to an Nth mobile computing device 218), one or more vehicle “X” sensors (shown here as a first vehicle “X” sensor 220 up to an Nth vehicle “X” sensor 222), one or more actuarial computing devices (shown here as a first actuarial computing device 224 up to an Nth actuarial computing device 226), one or more vehicle “Y” sensors (shown here as a first vehicle “Y” sensor 228 up to an Nth vehicle “Y” sensor 230), one or more vehicle “Z” sensors (shown here as a first vehicle “Z” sensor 232 up to an Nth vehicle “Z” sensor 234), and one or more user profiles (shown here as a first user profile 236 up to an Nth user profile 238), each of which can be implemented as a computer system or part of a computing system.

In practice, the safe driving system 200 illustrated in FIG. 2B is likely to include many or some or all of the example components described above in FIGS. 2A and 2B, which can allow a network of many policyholders and/or potential customers to communicate and interact with and contribute to the analysis performed by the modeling computing device 202, as well as the insurance company, the insurance company to communicated and interact with the policyholder and/or potential customer, and so on.

For example, with safe driving system 200, modeling computing device 202 may collect data from a number of sources connected and/or related to the one or more use profiles (shown here as a first user profile 236 up to an Nth user profile 238). The user profiles (shown here as a first user profile 236 up to an Nth user profile 238) are used to identify the operator of the vehicle and may include: (i) the insurance policy held by the operator, (ii) the operator's name, (iii) the operator's age, (iv) the operator's vehicle, (v) the operator's marital status, and (vi) the number of children the operator has, among other possibilities.

In one example the modeling computing device 202 may collect data from one or more mobile computing devices (e.g., used in connection with one or more separate vehicles) associated with a user profile (shown here as a first mobile computing device 216 up to an Nth mobile computing device 218, and a first user profile 236 up to an Nth user profile 238 respectively). In a further aspect, these one or more mobile computing devices may include a mobile computing device associated with the driver (e.g., the driver's cellular device/smartphone), a mobile computing device associated with the vehicle (e.g., a computing system, and/or head unit installed in the vehicle), or both, among other possibilities. The data collected from these mobile computing devices may include operational data of a vehicle (e.g., speed and direction of travel for the vehicle), as well as data indicating driver behavior inside the vehicle, including: (i) how often the operator interacts with the mobile computing device while operating the vehicle, (ii) a gazing direction of the operator of the mobile computing device while operating the vehicle, and (iii) how often the operator interacts with one or more particular applications on the mobile computing device while operating the vehicle, among other possibilities. This data may come from one or more of the following sensors of the mobile computing devices, and/or vehicle, associated with the user profile: (i) GPS sensors; (ii) accelerometer sensors; (iii) device interaction sensor; (iv) time sensor, (v) weather sensors, (vi) collision sensors, and (vii) camera sensors, among other possibilities.

In another example, modeling computing device 202 may collect data from one or more vehicle “X” sensors, potentially on one or more different vehicles, associated with a user profile (shown here as a first vehicle “X” sensor 220 up to an Nth vehicle “X” sensor 222, and a first user profile 236 up to an Nth user profile 238 respectively). This vehicle sensor data may include one or more of the following for one or more vehicles associated with a user profile: (i) frequency of which the operator drives the vehicle, (ii) accelerometer data, (iii) routes taken by the operator of the vehicle, (iv) average distance per day driven by the operator of the vehicle, (v) environmental condition in which the operator of vehicle operates the vehicle, (vi) behavior data of the operator of the vehicle collected by the mobile computing device associated with the user profile, and (vii) behavior data of the operator of the vehicle based on the received vehicle sensor data, among other possibilities.

In yet another example, modeling computing device 202 may collect data from one or more actuarial computing devices (shown here as a first actuarial computing device 224 up to an Nth actuarial computing device 226) collecting data regarding, and/or otherwise indicating information about, operators and vehicles similar to the operator and vehicle associated with the user profile (shown here as a first user profile 236 up to an Nth user profile 238 respectively). The actuarial data may include historical actuarial data compiled by an insurance company, among other things.

In further examples, modeling computing device 202 may collect data from one or more vehicle sensors “Y” and “Z” (shown here as a first vehicle “Y” sensor 228 up to an Nth vehicle “Y” sensor 230, and a first vehicle “Z” sensor 232 up to an Nth vehicle “Z” sensor 234 respectively) which share one or more attributes of a vehicle associated a user profile (shown here as a first user profile 236 up to an Nth user profile 238 respectively). These vehicle attributes may include one or more of the following: (i) the make and model of the vehicle, (ii) one or more purchased options of the vehicle, (iii) one or more potential vehicle options of the vehicle, (iv) an operating system of the vehicle, (v) an ADAS software developer of the vehicle, and (vi) one or more available vehicle subscription services of the vehicle, among other things.

Once the modeling computing device 202 collects data from the network of one or more mobile computing devices, one or more vehicle “X” sensors, one or more actuarial computing devices, one or more vehicle “Y” sensors, one or more vehicle “Z” sensors, and one or more user profiles illustrated in FIG. 2B, among other sources, the modeling computing device 202 may then generate a comprehensive safe driving model using one or more machine learning models (e.g., a naïve Bayes classifier machine learning model). In example embodiments, this safe driving model may be constructed using any or all of the data collected from the network of one or more mobile computing devices, one or more vehicle “X” sensors, one or more actuarial computing devices, one or more vehicle “Y” sensors, one or more vehicle “Z” sensors, and one or more user profiles, and/or other sources. In this way, the safe driving model may include sensor, actuarial, mobile computing, and user profile data for a number of vehicles operating within the same network (e.g., the insurance network), any or all of which may include members with a diverse pool of vehicles and backgrounds. Furthermore, the safe driving model may be updated over time based on further data collected from these sources.

For example, after the safe driving model is generated and/or regenerated by the modeling computing device 202, the modeling computing device may receive a request for updated driver safety recommendations from a first mobile computing device 216. In response to this request, modeling computing device 202 may identify one or more attributes of the vehicle being operated (e.g., the current ADAS software version), and determine if any improvements can be made (e.g., an update to the software is available). These attributes of the vehicle, and deficiencies thereof, may be based on data collected by one or more vehicles operating within the network based on vehicle “X,” “Y,” or “Z” sensors (Shown here as a first vehicle “X” sensor 220 up to an Nth vehicle “X” sensor 222, a first vehicle “Y” sensor 228 up to an Nth vehicle “Y” sensor 230, and a first vehicle “Z” sensor 232 up to an Nth vehicle “Z” sensor 234 respectively), among other possibilities.

For example, for drivers that have opted to use the safe driving system 200, one or more mobile computing devices (shown here as a first mobile computing device 216 up to an Nth mobile computing device 218) may be used to updated the safe driving model and/or one or more attributes of the one or more driver safety recommendations for drivers within the network. For example, one or more mobile computing devices in the region may indicate that one or more drivers are interacting with their respective mobile devices in a manner that decreases driver safety (e.g., several drivers within the network are texting while driving).

Furthermore, in some examples, these indications of decreased driver safety may indicate a decrease in driver safety amongst drivers sharing certain attributes with the operator (e.g., drivers within the same age group). In this way, because the safe driving model may be updated over time based on data collected from a network of vehicle sensors, mobile computing devices, actuarial computing devices, user profiles, and/or other sources, the attributes identified by the modeling computing device 202 may be updated and utilized for targeted analysis as well. For example, considering the safe driving model and/or one or more attributes of the one or more vehicles operated within the network, driver behavior associated with one or more mobile computing devices being used while operating a particular make and model of a vehicle might indicate increased risk and/or insurance premiums associated with the use of the mobile computing device while operating said vehicle, among other possibilities.

In another example, the modeling computing device may identify suggestion prompts for the mobile computing device based on this network of vehicle sensors, mobile computing devices, actuarial computing devices, user profiles, and/or other sources of data, including suggestion prompts relating to improving driver behavior and/or vehicle performance (e.g., installing ADAS software updates), among other possibilities. Furthermore, one or more mobile computing devices may display (e.g., via a user interface of the mobile computing device), one or more graphical indication of the following: (i) a recommendation to update a software associated with the vehicle, (ii) a recommendation to delegate more control to the ADAS, (iii) a recommendation to activate additional safety features of the vehicle, and (iv) a recommendation to disable certain applications while the vehicle is in motion, among other possibilities. The mobile computing device, as part of the graphical indication of the safety recommendations, may also display graphical indications of reductions in insurance costs including one or more of the following: (i) reductions in monthly premiums, (ii) partial rebates, and (iii) reduction in deductibles, among other possibilities. In a further aspect, the mobile computing device may also update this display at various times while the vehicle is stopped and/or parked (or other times) for a variety of reasons. Other examples are possible.

In some examples, some or all of the data collected in connection the user profile may be used to generate a digital record and/or representation of the user profile and/or one or more users associated with the user profile. For example, if a user associated with a particular user profile elects to change insurers, then some or all of the data collected in connection with the particular user profile may be transferred to the new insurer-including whether the user elected to accept or decline the safety recommendations displayed by the mobile computing device. In another example, some or all of the data collected in connection with the particular user profile may be used to validate that the user of the vehicle that is currently signed into a particular user profile is actually the user that is associated with the user profile (e.g., by detecting driving anomalies compared to the user's driver behavior in the past). Other examples are possible.

### C. Example Graphical User Interfaces

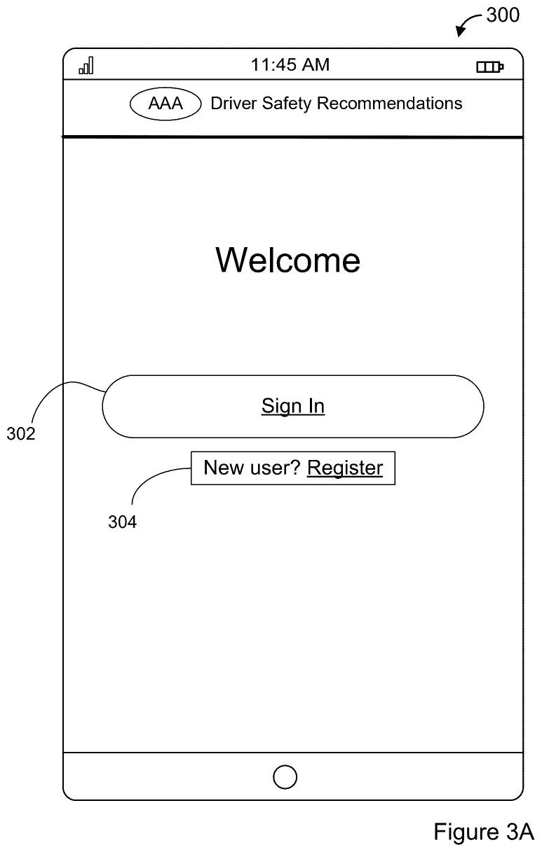

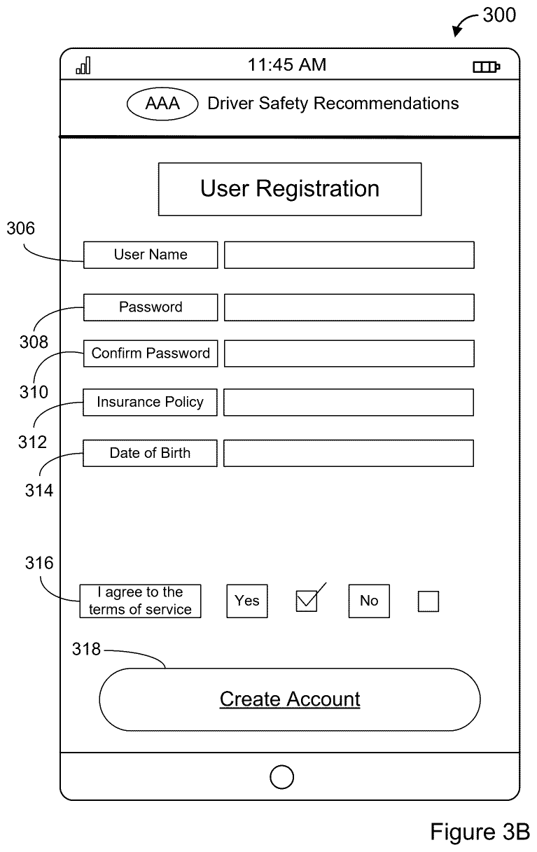

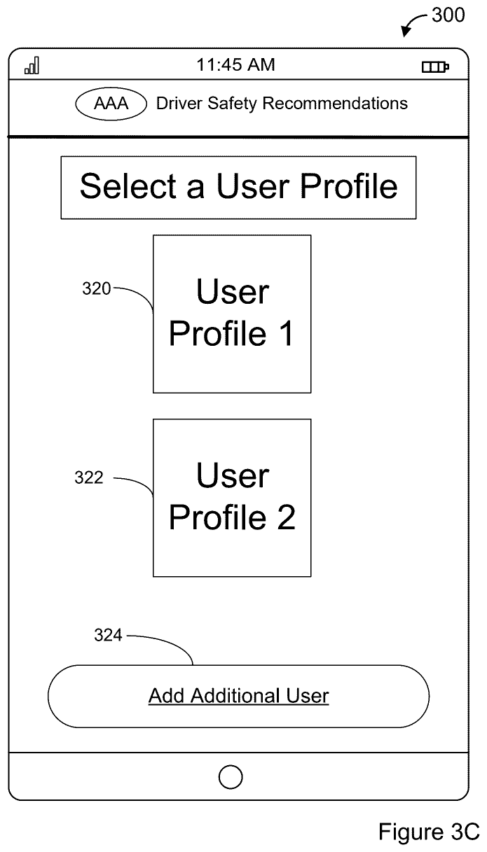

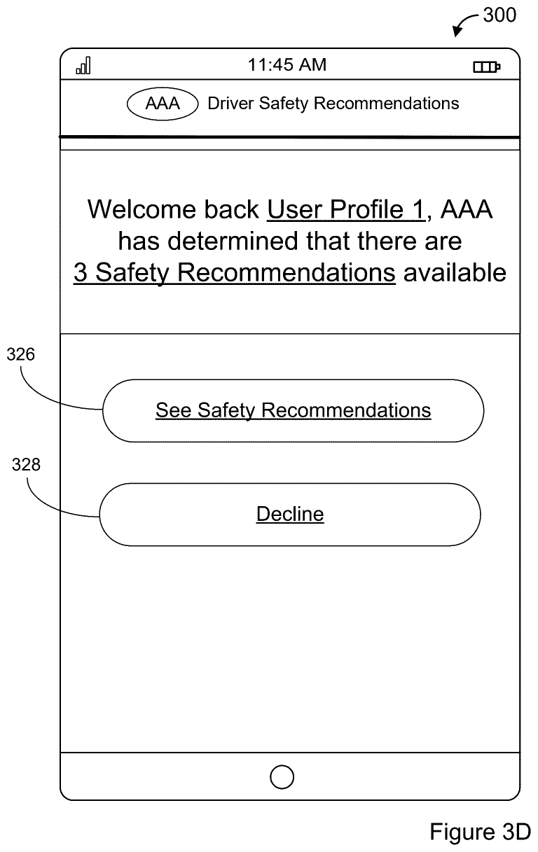

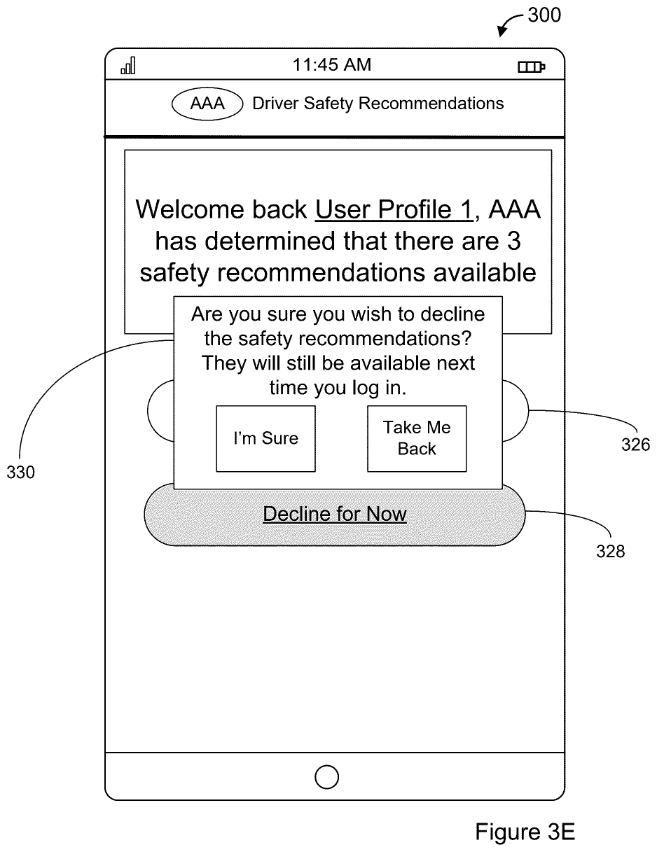

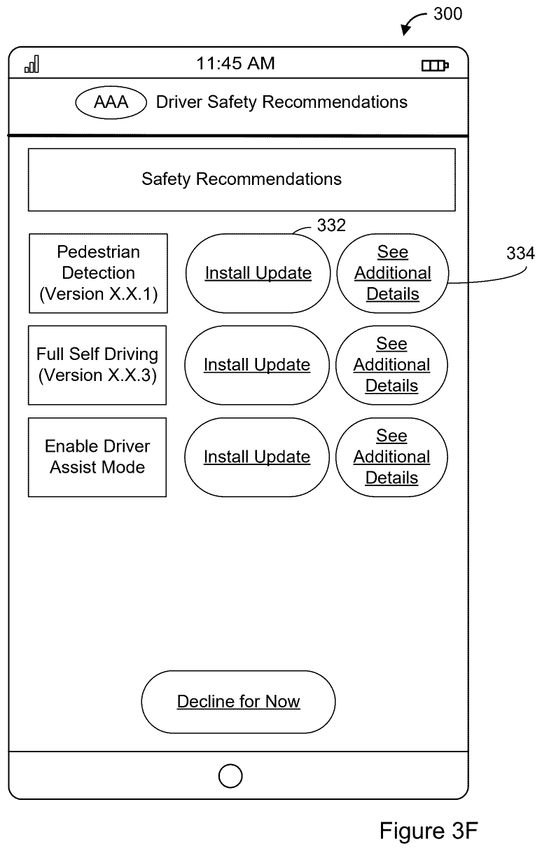

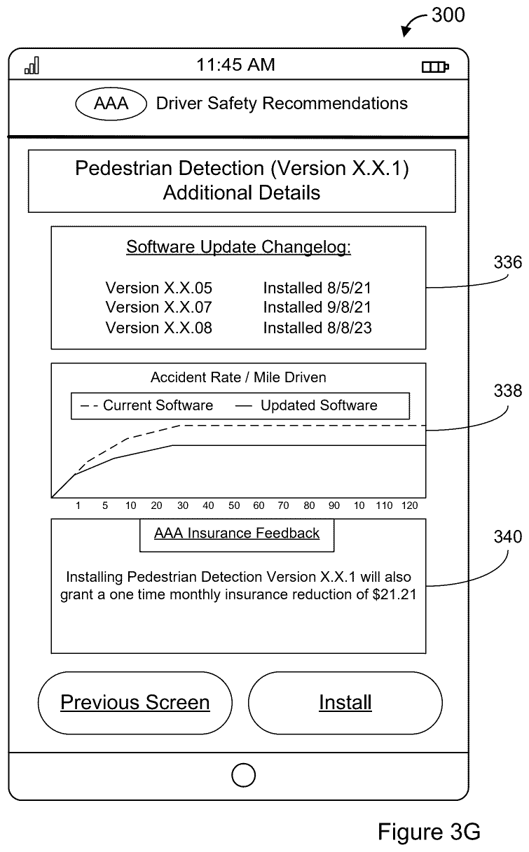

To further illustrate the above-described concepts and others, FIGS. 3A-3G depict a graphical user interface, in accordance with example embodiments. Although illustrated in FIGS. 3A-3G as being displayed via a user interface of a mobile computing device, this graphical user interface may be provided for display by one or more components described in connection with safe driving system 200 (e.g., via a user interface of mobile computing device 204), among other possibilities.

The information displayed by the graphical user interfaces may also be derived, at least in part, from data stored and processed by the components described in connection with the safe driving system 200, and/or other computing devices or systems configured to generate such graphical user interfaces and/or receive input from one or more users (e.g., those described in connection with safe driving system 200, as well as the components of FIGS. 1 and 2A-2B). This graphical user interface is merely for the purpose of illustration. The features described herein may involve graphical user interfaces that format information differently, include more or less information, include different types of information, and relate to one another in different ways.

Turning to FIGS. 3A-3G, FIGS. 3A-3G depict an example graphical user interface 300 in various states. Graphical user interface 300 includes visual representations that notify the user of a computing device associated with the vehicle, the safe driving system, or both that one or more safety recommendations may improve the performance and safety of an ADAS vehicle and presents the user with visual indications of such safety recommendations and other information associated with the recommendations and/or various actions that may be taken in response to the detected information.

Specifically, in the context of FIG. 3A, FIG. 3A depicts an example graphical user interface 300 illustrated in a first state. In FIG. 3A, graphical user interface 300 displays a sign in prompt 302 and a registration prompt 304, which prompts the user of the mobile computing device to create a user profile.

Turning to FIG. 3B, FIG. 3B depicts the example graphical user interface 300 of FIG. 3A, but illustrated in a second state, after the user selects registration prompt 304. In FIG. 3B, graphical user interface 300 displays a user name prompt 306, a password prompt 308, a confirm password prompt 310, an insurance policy prompt 312, a date of birth prompt 314, a terms of service prompt, and an account creation prompt 318, all of which prompts the user of the mobile computing device to enter information associated with generating a user profile.

Turning to FIG. 3C, FIG. 3C depicts the example graphical user interface 300 illustrated in a third state. After a user enters the values to generate a user profile and the user profile is generated, the graphical user interface 300 displays a first user profile prompt 320 and a second user profile prompt 322, as well as an additional user prompt 324. Once the user reviews the information displayed on graphical user interface 300, the user may select that he/she/they would like to proceed with one of the displayed user profile options.

Turning to FIG. 3D, FIG. 3D depicts the example graphical user interface 300 illustrated in a fourth state. In FIG. 3D, the user has selected to proceed with the first user profile via first user profile prompt 320 and graphical user interface 300 displays additional information pertaining to the first user profile. In FIG. 3D, a safe driving system (such as the safe driving system 200 detailed in connection with FIGS. 2A-2B above) has determined that there are three potential safety recommendations available for the first user profile (illustrated in FIG. 3D as “Welcome back User Profile 1, AAA has determined that there are 3 Safety Recommendations available”). In FIG. 3D, the user is also presented with an accept safety recommendations prompt 326 and a decline safety recommendations prompt 328.

Turning to FIG. 3E, FIG. 3E depicts the example graphical user interface 300 illustrated in a fifth state. In FIG. 3E, the user has selected to decline the safety recommendations via decline safety recommendations prompt 328 and graphical user interface 300 displays an additional decline prompt 330 to confirm that the user does not want to receive or accept the safety recommendations. In example embodiments, if the user proceeds with declining the safety recommendations (e.g., by selecting “I'm Sure”), then the mobile computing device may transmit an instruction to the safe driving system to create a record associated with the first user profile that the safety recommendations generated by the safe driving system were declined by the user-which in turn may affect a number of data records and/or models associated with the first user profile (e.g., insurance premiums, future safety recommendations for the user profile, etc.).

Alternatively, turning to FIG. 3F, FIG. 3F depicts the example graphical user interface 300 illustrated in a sixth state. In FIG. 3F, the user has selected to receive the safety recommendations via accept safety recommendations prompt 326 and graphical user interface 300 displays graphical indications of the three safety recommendations generated by the safe driving system, illustrated in FIG. 3F as “Pedestrian Detection (Version X.X.1)”, “Full Self Driving (Version X.X.3)”, and “Enable Driver Assist Mode”, each of which has an installation prompt 332 and an additional information prompt 334. In example embodiments, if the user proceeds with installing any of the safety recommendations (e.g., by selecting “Install Update”), then the mobile computing device may transmit an instruction to the safe driving system to install the update on the vehicle associated with the user profile and create a record associated with the first user profile that the safety recommendations generated by the safe driving system were accepted by the user-which in turn may affect a number of data records and/or models associated with the first user profile (e.g., insurance premiums, future safety recommendations for the user profile, etc.).

In FIG. 3G, the user has selected to receive additional details about one of the safety recommendations (“Pedestrian Detection (Version X.X.1)) via additional information prompt 334 and graphical user interface 300 displays graphical indications of forecasts and other information generated by the safe driving system that is associated with the particular safety recommendation. In FIG. 3G, graphical user interface 300 displays a software changelog chart 336 that indicates all the versions of the software that have been installed and associated with the user profile to date (as well as the date each was installed) in connection with the safety recommendation. In FIG. 3G, graphical user interface 300 also displays a safety recommendation forecast chart 338, which provides the user of the mobile computing device with one or more projections of how installing the recommended (e.g., most current) version of the software will decrease the accident rate over one or more periods of time, and an associated feedback prompt 340, which provides the user of the mobile computing device with one or more indications of how installing the recommended version of the software will benefit him/her/them in ways other than improving safety. In this regard, graphical user interface 300 may also assist the user in better understanding (and adjusting to) safety recommendations generated by the safe driving system, and improve driver safety and/or lower insurance premiums. Other examples are possible, any or all of which may be personalized for one or more particular drivers, vehicles, and/or user profiles based on ADAS data, driving data, and/or driver behavior data described above in the context of, for example, FIGS. 2A-2B.

Further, as described in further detail above, the graphical indications in FIGS. 3A-3F may vary in real time based, for example, on updated sensor data (e.g., using updated sensor data and environmental data of vehicles and/or sensors operating within the area) and/or recursively regenerated safe driving models for one or more vehicles and/or associated user profiles, among other possibilities. Other examples and/or additional information and prompts for display via graphical user interface 300 are possible.

These example graphical user interfaces are merely for purposes of illustration. The features described herein may involve graphical user interfaces that are configured or formatted differently, include more or less information and/or additional or fewer instructions, include different types of information and/or instructions, and relate to one another in different ways.

### C. Example Method

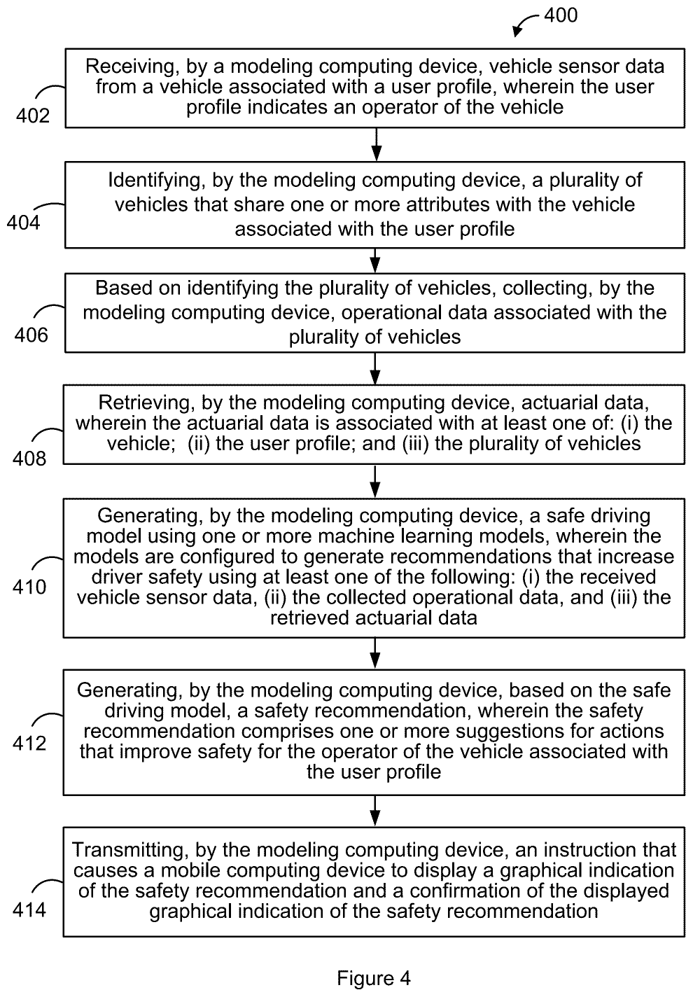

FIG. 4 is a flow chart illustrating an example method 400.

At block 402, the method 400 can include, receiving, by a modeling computing device, vehicle sensor data from a vehicle associated with a user profile, wherein the user profile indicates an operator of the vehicle. In some examples, the vehicle sensor data from a vehicle associated with the user profile comprises one or more of the following: (i) frequency of which the operator drives the vehicle, (ii) accelerometer data, (iii) routes taken by the operator of the vehicle, (iv) average distance per day driven by the operator of the vehicle, (v) environmental condition in which the operator of the vehicle operates the vehicle, (vi) behavior data of the operator of the vehicle collected by the mobile computing device associated with the user profile, and (vii) behavior data of operator of the vehicle based on the received vehicle sensor data. In some examples, the behavior data comprises one or more of the following: (i) how often the operator interacts with the mobile computing device while operating the vehicle, (ii) a gazing direction of the operator of the mobile computing device while operating the vehicle, and (iii) how often the operator interacts with one or more particular applications on the mobile computing device while operating the vehicle. In some examples, the sensor data collected from the vehicle associated with the user profile further comprises vehicle sensor data from a vehicle associated with one or more of: (i) another user profile; and (ii) a particular insurance plan.

At block 404, the method 400 can include, identifying, by the modeling computing device, a plurality of vehicles that share one or more attributes with the vehicle associated with the user profile. In some examples, the attributes shared between the vehicle associated with the user profile and the plurality of vehicles comprise one or more of the following: (i) the make and model of the vehicle, (ii) one or more purchased options of the vehicle, (iii) one or more potential vehicle options of the vehicle, (iv) an operating system of the vehicle, (v) an ADAS software developer of the vehicle, and (vi) one or more available vehicle subscription services of the vehicle.

At block 406, the method 400 can include based on identifying the plurality of vehicles, collecting, by the modeling computing device, operational data associated with the plurality of vehicles. In some examples, the operational data associated with the plurality of vehicles comprises one or more of the following: (i) use of an ADAS in one or more of the plurality of vehicles, (ii) success rate of ADAS detection of pedestrians by one or more of the plurality of vehicles, (iii) success rate of ADAS response to detected pedestrians by one or more of the plurality of vehicles, (iv) success rate of ADAS detection of other vehicles by one or more of the plurality of vehicles, (v) success rate of ADAS response to detected other vehicles by one or more of the plurality of vehicles, (vi) success rate of ADAS detection of road conditions by one or more of the plurality of vehicles, (vii) success rate of ADAS response to detected road conditions by one or more of the plurality of vehicles, (viii) success rate of ADAS detection of traffic conditions by one or more of the plurality of vehicles, (ix) success rate of ADAS response to detected traffic conditions by one or more of the plurality of vehicles, (x) success rate of ADAS path suggestion through environment by one or more of the plurality of vehicles, and (xi) details of a respective software of one or more of the plurality of vehicles.

At block 408, the method 400 can also include, retrieving, by the modeling computing device, actuarial data, wherein the actuarial data is associated with at least one of: (i) the vehicle; (ii) the user profile; and (iii) the plurality of vehicles. In some examples, the actuarial data comprises historical actuarial data compiled by an insurance company. In some examples, the actuarial data comprises one or more of the following: (i) age of the operator of the vehicle, (ii) age of one or more operators of one or more of the plurality of vehicles, (iii) an accident record of the operator of the vehicle, (iv) an accident record of one or more operators of one or more of the plurality of vehicles, (v) accident rate of a make and model of the vehicle, (vi) costs associated with repairing damage from accidents of a make and model of the vehicle, (vii) features of the vehicle, and (viii) safety ratings of the vehicle.

At block 410, the method 400 can also include, generating, by the modeling computing device, a safe driving model using one or more machine learning models, wherein the models are configured to generate recommendations that increase driver safety using at least one of the following: (i) the received vehicle sensor data, (ii) the collected operational data, and (iii) the retrieved actuarial data. In some examples, the one or more machine learning models comprise one or more of: (i) a naïve Bayes machine learning model, (ii) a K-nearest neighbors machine learning model, (iii) a deep learning model, (iv) a logistic regression model, and (v) a gradient boosting regression model. In some examples, generating the safe driving model further comprises at least one of the following: (i) generating recommendations based on predicted future improvements in ADAS related software based on improvements over previous iterations of the software; and (ii) generating recommendations based on actual improvements in ADAS related software exceeding predictions.

At block 412, the method 400 can also include, generating, by the modeling computing device, based on the safe driving model, a safety recommendation, wherein the safety recommendation comprises one or more suggestions for actions that improve safety for the operator of the vehicle associated with the user profile. In some examples, the safety recommendation comprises one or more of the following: (i) a recommendation to update a software associated with the vehicle, (ii) a recommendation to delegate more control to the ADAS, and (iii) a recommendation to activate additional safety features of the vehicle

At block 414, the method 400 can also include, transmitting, by the modeling computing device, an instruction that causes a mobile computing device to display a graphical indication of the safety recommendation and a confirmation of the displayed graphical indication of the safety recommendation. In some examples, the graphical indication of the safety recommendation comprises displaying graphical indications of reductions in insurance costs comprising one or more of the following: (i) reductions in monthly premiums, (ii) partial rebates, and (iii) reductions in deductibles.

In other examples embodiments, the method 400 includes processing the data collected using a plurality of data compression techniques, wherein the data compression techniques reduce overfitting by combining variables with a high correlation, using the compressed data sets to improve pre-ingestion of the machine learning model, and using the compressed data sets to improve real time analysis done by the safe driving model.

In other examples embodiments, the method 400 includes creating compressed data sets by processing at least one of the following: (i) the received vehicle sensor data, (ii) the collected operational data, and (iii) the retrieved actuarial data, by using a plurality of data compression techniques, wherein the data compression techniques reduce overfitting by combining variables with a high correlation and inputting the compressed data sets to improve performance of the one or more machine learning models and the safe driving model. In some examples, the data compression techniques comprise one or more of the following: (i) a principle component analysis method and (ii) a factor analysis method.

### III. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

We claim:

1. A system for improving safety while operating advanced driver assistance systems (ADAS) vehicles, the system comprising:
a modeling computing device, wherein the modeling computing device comprises a processor and a non-transitory computer-readable medium, having stored thereon program instructions that, upon execution by the processor, cause the modeling computing device to perform a set of operations comprising:
receiving vehicle sensor data from a vehicle associated with a user profile, wherein the user profile indicates an operator of the vehicle;
identifying a plurality of vehicles that share one or more attributes with the vehicle associated with the user profile;
based on identifying the plurality of vehicles, collecting operational data associated with the plurality of vehicles;
retrieving actuarial data, wherein the actuarial data is associated with at least one of: (i) the vehicle; (ii) the user profile; and (iii) the plurality of vehicles;
generating a safe driving model using one or more machine learning models, wherein the models are configured to generate recommendations that increase driver safety using at least one of the following: (i) the received vehicle sensor data, (ii) the collected operational data, and (iii) the retrieved actuarial data; and
generating, based on the safe driving model, a safety recommendation, wherein the safety recommendation comprises one or more suggestions for actions that improve safety for the operator of the vehicle associated with the user profile; and
a mobile computing device associated with the user profile, wherein the mobile computing device comprises a processor and a non-transitory computer-readable medium, having stored thereon program instructions that, upon execution by the processor, cause the mobile computing device to perform a set of operations comprising:
receiving, from the modeling computing device, the safety recommendation;
displaying, via a user interface of the mobile computing device, a graphical indication of the safety recommendation; and
receiving, via the user interface of the mobile computing device, a confirmation of the displayed graphical indication of the safety recommendation.

2. The system of claim 1, wherein the vehicle sensor data from a vehicle associated with the user profile comprises one or more of the following: (i) frequency of which the operator drives the vehicle, (ii) accelerometer data, (iii) routes taken by the operator of the vehicle, (iv) average distance per day driven by the operator of the vehicle, (v) environmental condition in which the operator of the vehicle operates the vehicle, (vi) behavior data of the operator of the vehicle collected by the mobile computing device associated with the user profile, and (vii) behavior data of operator of the vehicle based on the received vehicle sensor data.

3. The system in claim 2, wherein the behavior data comprises one or more of the following: (i) how often the operator interacts with the mobile computing device while operating the vehicle, (ii) a gazing direction of the operator of the mobile computing device while operating the vehicle, and (iii) how often the operator interacts with one or more particular applications on the mobile computing device while operating the vehicle.

4. The system of claim 1, wherein the attributes shared between the vehicle associated with the user profile and the plurality of vehicles comprise one or more of the following: (i) make and model of the vehicle, (ii) one or more purchased options of the vehicle, (iii) one or more potential vehicle options of the vehicle, (iv) an operating system of the vehicle, (v) an ADAS software developer of the vehicle, and (vi) one or more available vehicle subscription services of the vehicle.

5. The system of claim 1, wherein the operational data associated with the plurality of vehicles comprises one or more of the following: (i) use of an ADAS in one or more of the plurality of vehicles, (ii) success rate of ADAS detection of pedestrians by one or more of the plurality of vehicles, (iii) success rate of ADAS response to detected pedestrians by one or more of the plurality of vehicles, (iv) success rate of ADAS detection of other vehicles by one or more of the plurality of vehicles, (v) success rate of ADAS response to detected other vehicles by one or more of the plurality of vehicles, (vi) success rate of ADAS detection of road conditions by one or more of the plurality of vehicles, (vii) success rate of ADAS response to detected road conditions by one or more of the plurality of vehicles, (viii) success rate of ADAS detection of traffic conditions by one or more of the plurality of vehicles, (ix) success rate of ADAS response to detected traffic conditions by one or more of the plurality of vehicles, (x) success rate of ADAS path suggestion through environment by one or more of the plurality of vehicles, and (xi) details of a respective software of one or more of the plurality of vehicles.

6. The system of claim 1, wherein actuarial data comprises historical actuarial data compiled by an insurance company.

7. The system of claim 1, wherein the actuarial data comprises one or more of the following: (i) age of the operator of the vehicle, (ii) age of one or more operators of one or more of the plurality of vehicles, (iii) an accident record of the operator of the vehicle, (iv) an accident record of one or more operators of one or more of the plurality of vehicles, (v) accident rate of a make and model of the vehicle, (vi) costs associated with repairing damage from accidents of a make and model of the vehicle, (vii) features of the vehicle, and (viii) safety ratings of the vehicle.

8. The system of claim 1, wherein one or more of the machine learning models comprises one or more of: (i) a naïve Bayes machine learning model, (ii) a K-nearest neighbors machine learning model, (iii) a deep learning model, (iv) a logistic regression model, and (v) a gradient boosting regression model.

9. The system of claim 1, wherein the safety recommendation comprises one or more of the following: (i) a recommendation to update a software associated with the vehicle, (ii) a recommendation to delegate more control to the ADAS, and (iii) a recommendation to activate additional safety features of the vehicle.

10. The system of claim 1, wherein the graphical indication of the safety recommendation comprises displaying graphical indications of reductions in insurance costs comprising one or more of the following: (i) reductions in monthly premiums, (ii) partial rebates, and (iii) reductions in deductibles.

11. The system of claim 1, wherein the sensor data collected from the vehicle associated with the user profile further comprises vehicle sensor data from a vehicle associated with one or more of: (i) another user profile; and (ii) a particular insurance plan.

12. The system of claim 1, wherein the set of operations further comprises:
creating compressed data sets by processing at least one of the following: (i) the received vehicle sensor data, (ii) the collected operational data, and (iii) the retrieved actuarial data, by using a plurality of data compression techniques, wherein the data compression techniques reduce overfitting by combining variables with a high correlation; and
inputting the compressed data sets to improve performance of the one or more machine learning models and the safe driving model.

13. The system of claim 12, wherein the plurality of data compression techniques comprises one or more of the following: (i) a principle component analysis method and (ii) a factor analysis method.

14. The system of claim 1, wherein generating the safe driving model further comprises at least one of the following:
generating recommendations based on predicted future improvements in ADAS related software based on improvements over previous iterations of the software; and
generating recommendations based on actual improvements in ADAS related software exceeding predictions.

15. A method comprising:
receiving, by a modeling computing device, vehicle sensor data from a vehicle associated with a user profile, wherein the user profile indicates an operator of the vehicle;
identifying, by the modeling computing device, a plurality of vehicles that share one or more attributes with the vehicle associated with the user profile;
based on identifying the plurality of vehicles, collecting, by the modeling computing device, operational data associated with the plurality of vehicles;
retrieving, by the modeling computing device, actuarial data, wherein the actuarial data is associated with at least one of: (i) the vehicle; (ii) the user profile; and (iii) the plurality of vehicles;
generating, by the modeling computing device, a safe driving model using one or more machine learning models, wherein the models are configured to generate recommendations that increase driver safety using at least one of the following: (i) the received vehicle sensor data, (ii) the collected operational data, and (iii) the retrieved actuarial data;
generating, by the modeling computing device, based on the safe driving model, a safety recommendation, wherein the safety recommendation comprises one or more suggestions for actions that improve safety for the operator of the vehicle associated with the user profile; and
transmitting, by the modeling computing device, an instruction that causes a mobile computing device to display a graphical indication of the safety recommendation and a confirmation of the displayed graphical indication of the safety recommendation.

16. The method of claim 15, wherein the vehicle sensor data from a vehicle associated with the user profile comprises one or more of the following: (i) frequency of which the operator drives the vehicle, (ii) accelerometer data, (iii) routes taken by the operator of the vehicle, (iv) average distance per day driven by the operator of the vehicle, (v) environmental condition in which the operator of the vehicle operates the vehicle, (vi) behavior data of the operator of the vehicle collected by the mobile computing device associated with the user profile, and (vii) behavior data of operator of the vehicle based on the received vehicle sensor data.

17. The method of claim 15, wherein the attributes shared between the vehicle associated with the user profile and the plurality of vehicles comprise one or more of the following: (i) make and model of the vehicle, (ii) one or more purchased options of the vehicle, (iii) one or more potential vehicle options of the vehicle, (iv) an operating system of the vehicle, (v) an ADAS software developer of the vehicle, and (vi) one or more available vehicle subscription services of the vehicle.

18. The method of claim 15, wherein the operational data associated with the plurality of vehicles comprises one or more of the following: (i) use of an ADAS in one or more of the plurality of vehicles, (ii) success rate of ADAS detection of pedestrians by one or more of the plurality of vehicles, (iii) success rate of ADAS response to detected pedestrians by one or more of the plurality of vehicles, (iv) success rate of ADAS detection of other vehicles by one or more of the plurality of vehicles, (v) success rate of ADAS response to detected other vehicles by one or more of the plurality of vehicles, (vi) success rate of ADAS detection of road conditions by one or more of the plurality of vehicles, (vii) success rate of ADAS response to detected road conditions by one or more of the plurality of vehicles, (viii) success rate of ADAS detection of traffic conditions by one or more of the plurality of vehicles, (ix) success rate of ADAS response to detected traffic conditions by one or more of the plurality of vehicles, (x) success rate of ADAS path suggestion through environment by one or more of the plurality of vehicles, and (xi) details of a respective software of one or more of the plurality of vehicles.

19. The method of claim 15, wherein the actuarial data comprises historical actuarial data compiled by an insurance company.

20. The method of claim 15, wherein the method further comprises:
processing the data collected using a plurality of data compression techniques, wherein the data compression techniques reduce overfitting by combining variables with a high correlation;
using the compressed data sets to improve pre-ingestion of the machine learning model; and
using the compressed data sets to improve real time analysis done by the safe driving model.
